(19) United States
(12) Patent Application Publication
(10) Pub. No.: US 2009/0006114 A1
(43) Pub. Date: Jan. 1, 2009

(54) Multi-channel commerce-related data management

(75) Inventors: Ryan R. Donovan, Bellevue, WA (US); Jean-Yves Martineau, Gatineau (CA)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,920

(22) Filed: Jun. 26, 2007

(51) Int. Cl. G06Q 30/00; G06F 17/30

(52) U.S. Cl. 705/1; 707/104.1; 707/E17.005

(57) ABSTRACT

An approach to commerce-related data management is described that allows multiple heterogeneous enterprise application systems to utilize a centralized data store for managing and storing data generated and/or used by the enterprise application systems. One implementation of the commerce-related data management system includes a data store, business logic and Web services logic. The data store stores commerce-related data. The business logic is configured to access the commerce-related data stored in the data store. The Web services logic is configured to receive service requests transmitted by multiple heterogeneous enterprise application systems over a network. The business logic is further configured to perform one or more operations upon the commerce-related data stored in the data store responsive to receipt of the service requests by the Web services logic.

### BACKGROUND

Many business organizations that buy or sell goods or services must contend with the management and storage of large amounts of commerce-related data. Such commerce-related data may include, but is not limited to: product catalogs, master merchandise data, product inventories, customer profiles, organizational profiles, and marketing and promotional data such as customized pricing information.

As a business organization grows, it often adds new channels by which it can conduct its commercial activities. As each new line of business is added, the organization typically develops a unique enterprise application to support it. As a result, the organization's commerce-related data ends up being stored in multiple heterogeneous systems that span the breadth of the entire organization. Each system may redundantly store the same commerce-related data as one or more of the other systems. Examples of enterprise application systems that may redundantly store the same commerce-related data include, but are not limited to: in-store Point-of-Sale (POS) systems, kiosks, on-line Web storefronts (e-commerce systems), product line manager systems, product information management systems, inventory management systems, warehouse management systems, order management (OM) systems, supply chain automation systems and supply chain management (SCM) systems.

When the commerce-related data stored in one enterprise application system is duplicative of commerce-related data stored in other enterprise application systems, the business organization must keep the data stored in all such systems synchronized so as to maintain the integrity of the data as a whole. One approach to synchronizing the data is to use point-to-point solutions that interconnect individual systems.

Another approach to synchronizing the commerce-related data, illustrated in FIG. 1, involves using an Enterprise Application Integration (EAI) system 102 in a hub/spoke arrangement 100. In accordance with such an arrangement, EAI system 102 acts as the hub, interconnecting a plurality of enterprise application systems, each of which is connected to EAI system 102 via a separate communication channel or spoke. As shown in FIG. 1, the enterprise application systems may include an SCM system 104, an e-commerce system 106, a POS system 108, an OM system 110, a kiosk 112, a generic line of business system 114 and a system 116 for exchanging information with business-to-business (B2B) trading partners. However, these systems are included by way of example only. Any number of a wide variety of enterprise application systems may be interconnected by EAI system 102. Each enterprise application system maintains its own duplicative data store. EAI system 102 acts as a message broker between the diverse systems so that whenever data stored in one system is modified, the changes to the data are propagated to the other systems that also store copies of the same data.

The aforementioned storage of multiple copies of the same commerce-related data and the requirement of synchronizing that data across multiple heterogeneous systems represents a substantial integration cost for every modern business organization involved in commerce. In the future, the variety of channels over which commerce can be conducted will only increase. To remain competitive, a business organization will need to access such new lines of business as well as add enterprise application systems to support them. However, the data managed by each additional system will need to be synchronized with the data managed by existing systems, thereby further driving up the integration costs for the organization.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A commerce-related data management system is described herein that allows multiple heterogeneous enterprise application systems to utilize a centralized data store for managing and storing data generated and/or used by the enterprise application systems.

One implementation of the commerce-related data management system includes a data store, business logic and Web services logic. The data store stores commerce-related data. The business logic is configured to access the commerce-related data stored in the data store. The Web services logic is configured to receive service requests transmitted by multiple heterogeneous enterprise application systems over a network. The business logic is further configured to perform one or more operations upon the commerce-related data stored in the data store responsive to receipt of the service requests by the Web services logic. The service requests received from each of the multiple heterogeneous enterprise application systems may be formatted in accordance with a common source code structure.

A method for managing commerce-related data using a centralized data store is also described herein. The method may be used by a first enterprise application system and a second enterprise application system, wherein the first and second enterprise application systems are heterogeneous systems.

One implementation of the method includes receiving a first Web service request transmitted by the first enterprise application system over a network. Responsive to receiving the first Web service request, a first operation is performed upon commerce-related data stored in the data store. The method further includes receiving a second Web service request transmitted by the second enterprise application system over the network. Responsive to receiving the second Web service request, a second operation is performed upon the commerce-related data stored in the data store. The first and second Web service requests may each formatted in accordance with the same predefined source code structure.

A computer program product is also described herein. The computer program product includes a computer-readable medium having computer program logic recorded thereon for enabling a computer to manage commerce-related data stored in a data store.

In accordance with one implementation of the computer program product, the computer program logic includes first, second and third means. The first means are for enabling the computer to access the commerce-related data stored in the database. The second means are for enabling the computer to receive service requests transmitted by multiple heterogeneous enterprise application systems over a network. The third means are for enabling the computer to perform one or more operations upon the commerce-related data stored in the database responsive to receipt of the service requests by the second means. The second means may include means for enabling the computer to receive service requests formatted in accordance with a common source code structure.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a conventional system in which an Enterprise Application Integration (EAI) system is used to synchronize redundant commerce-related data managed by disparate enterprise application systems.

FIG. 2 is a block diagram of a multi-channel commerce-related data management system 200 in accordance with an embodiment of the present invention.

FIG. 3 is a high-level block diagram of a commerce platform and data store in accordance with an embodiment of the present invention.

FIG. 4 is a block diagram that depicts a specific implementation of the multi-channel commerce-related data management system of FIG. 2.

FIG. 5 depicts a system in which a centralized data store and a commerce platform facilitate the use of “punch out” technology by a variety of different business entity e-commerce applications in accordance with an embodiment of the present invention.

FIG. 6 is a block diagram illustrating a particular implementation of a commerce platform and a data store in accordance with an embodiment of the present invention.

FIG. 7 is a block diagram that illustrates a first mode by which an application may remotely invoke Web services provided by a commerce platform in accordance with an embodiment of the present invention.

FIG. 8 is a block diagram that illustrates a second mode by which an application may remotely invoke Web services provided by a commerce platform in accordance with an embodiment of the present invention.

FIG. 9 is a block diagram that illustrates a third mode by which an application may remotely invoke Web services provided by a commerce platform in accordance with an embodiment of the present invention.

FIG. 10 illustrates a flowchart a method for managing commerce-related data in accordance with an embodiment of the present invention.

FIGS. 11 and 12 each depicts a flowchart of steps that may be performed in addition to the steps of the flowchart of FIG. 9 in accordance with embodiments of the present invention.

FIG. 13 depicts an example server computer that may be used to implement a commerce platform and/or database server in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Multi-Channel Commerce-Related Data Management System

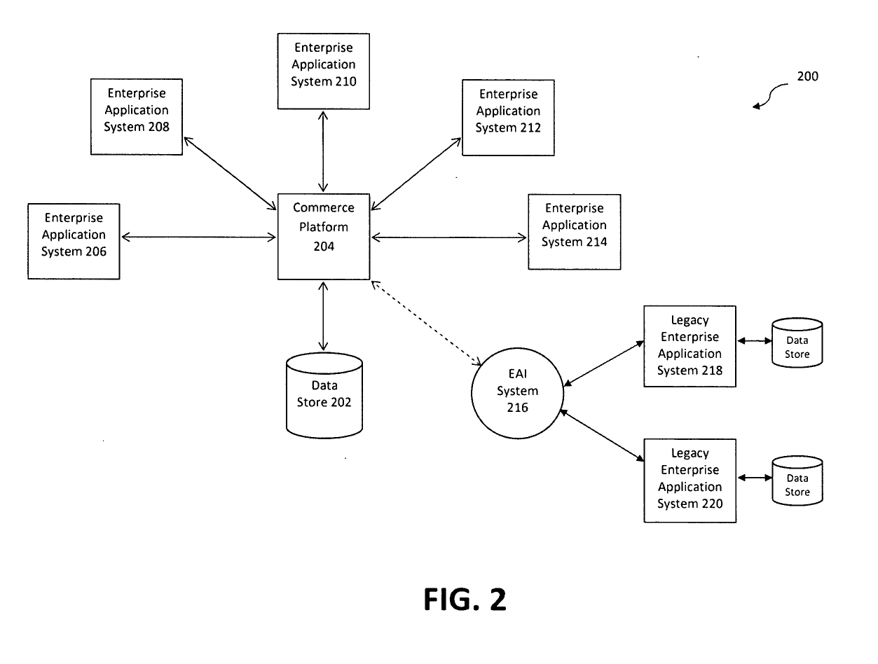

FIG. 2 is a block diagram of a multi-channel commerce-related data management system 200 in accordance with one embodiment. System 200 includes a centralized data store 202 that stores commerce-related data generated and/or used by a plurality of heterogeneous enterprise application systems 206, 208, 210, 212 and 214. As used herein, the term “enterprise application” refers to any automated process used for conducting or operating a business, while the term “enterprise application system” refers to any system that is used to run or support such a process. Enterprise application systems 206, 208, 210, 212 and 214 are heterogeneous in the sense that each utilizes a different hardware and/or software architecture for executing an enterprise application. As discussed in the Background section above, the heterogeneous nature of enterprise application systems 206, 208, 210, 212 and 214 may result from the fact that each system was independently developed and/or deployed to serve a single channel of commerce or line of business.

Although five heterogeneous enterprise application systems are depicted in FIG. 2, persons skilled in the relevant art(s) will readily appreciate that system 200 can support any number of heterogeneous enterprise application systems.

The commerce-related data stored by data store 202 may include any type of data generated and/or used by any of enterprise application systems 206, 208, 210, 212 and 214. Such commerce-related data may include, for example, product catalog information, master merchandise information, product inventory information, customer profile information, organizational profile information, and marketing or promotional information. However, these information types are provided by way of example only and are not intended to limit the present invention. Persons skilled in the relevant art(s) will understand that the commerce-related data stored in data store 202 may broadly include any type of data used to support or perform any type of commercial activity.

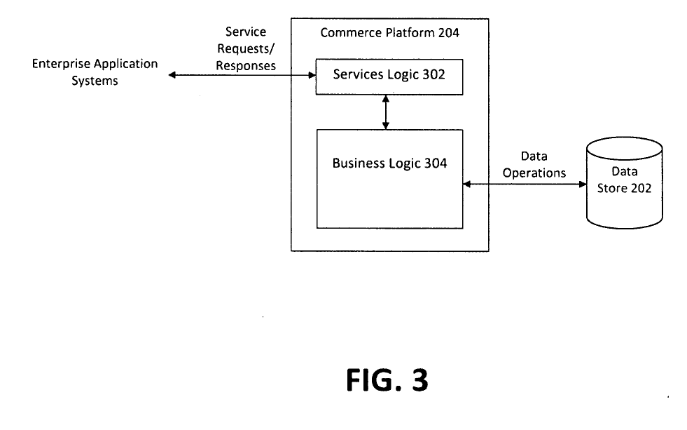

Access to data store 202 by each of heterogeneous enterprise application systems 206, 208, 210, 212 and 214 is managed by a commerce platform 204. As shown in FIG. 3, commerce platform 204 includes services logic 302 that is configured to receive service requests from each of the enterprise application systems and to optionally send responses to such service requests to the enterprise application systems. As also shown in FIG. 3, commerce platform 204 further includes business logic 304 that is configured to perform certain actions responsive to the receipt of such service requests by services logic 302, such as adding, deleting or modifying data in data store 202, returning a copy of data stored in data store 202, or performing some other action or operation with respect to the data stored in data store 202.

Services logic 302 within commerce platform 204 is configured such that it can receive service requests that are sent over a network and optionally provide responses to those service requests over the network. Consequently, each of enterprise application systems 206, 208, 210, 212 and 214 may be remotely located with respect to commerce platform 204 and data store 202. The network used for transporting such service requests may be any type of network that is capable of transporting data between remote entities, including but not limited to the Internet, an intranet, or an extranet.

In order that the same services logic and business logic can be used by commerce platform 204 to handle service requests received from each of heterogeneous enterprise application systems 206, 208, 210, 212 and 214, such service requests may be generated using one or more common source code structures. For example, such service requests may be generated using a common source code structure for performing Web service operations, and/or a common set of application programming interfaces (APIs). Furthermore, the service requests may refer to the same set of data entities stored in the central data store. As will be discussed in more detail herein, the service requests may be generated by the enterprise application system itself or by an intermediate entity that is connected between the enterprise application system and commerce platform 204.

In accordance with the architecture of system 200, data store 202 and commerce platform 204 serve as a centralized back-end for providing data management services to many different front-end commerce-related applications. This is fundamentally different from conventional scenarios in which each enterprise application system within an organization implements its own data store and in which point-to-point systems or Enterprise Application Integration (EAI) message brokers are used to synchronize the data stored by each system. By utilizing a system such as system 200, an organization can achieve considerable savings in terms of cost and complexity both during system deployment and on an ongoing operations basis. For example, during deployment of the system, only a single data store and a single set of services for accessing it need be implemented. Furthermore, during operation of the system, no resources need be spent storing the same commerce-related data in multiple data stores and keeping such data synchronized over time.

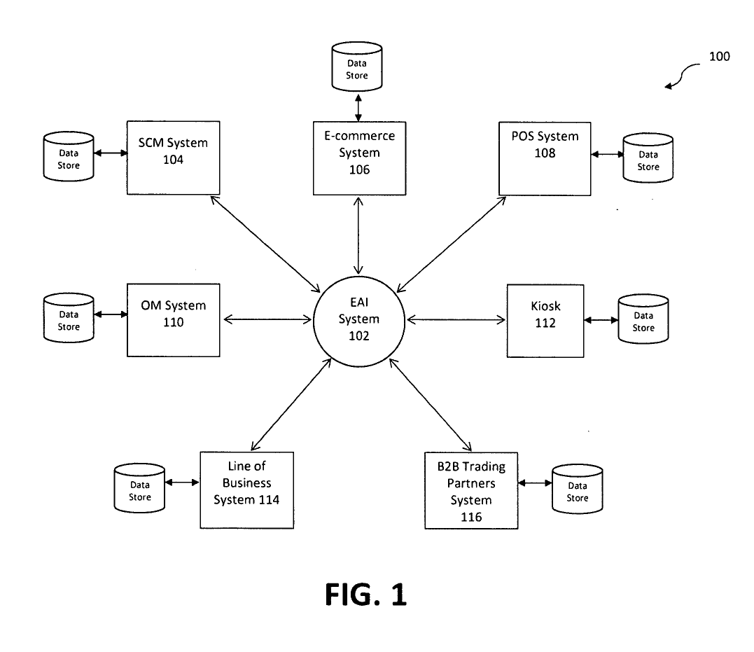

As further shown in FIG. 2, system 200 may also optionally include an EAI system 216 that is used to connect centralized data store 202 and commerce platform 204 to legacy enterprise application systems 218 and 220 that still maintain their own data stores. In such a scenario, EAI system 216 is used to ensure that data stored by legacy enterprise application systems 218 and 220 is kept synchronized with data stored in centralized data store 202. In this scenario, EAI system 216, as well as each of enterprise application systems 206, 208, 210, 212 and 214, may be thought of as a spoke and data store 202/commerce platform 204 as a hub that services each spoke. This is in contrast to the conventional approach to enterprise application integration depicted in FIG. 1, in which an EAI message broker acts as a hub that is used to synchronize different sets of commerce-related data stores arranged as spokes around the hub.

Although two legacy enterprise application systems are depicted in FIG. 2, persons skilled in the relevant art(s) will readily appreciate that system 200 can support any number of legacy enterprise application systems.

Because system 200 can accommodate legacy enterprise application systems, it can be incrementally deployed within conventional architectures in a phased manner. For example, data store 202 and commerce platform 204 can initially be used to implement a single channel of commerce within a business organization, such as an on-line e-commerce storefront or in-store POS system. This new back-end system can then gradually be rolled out to support other enterprise application systems within the organization. As each additional enterprise application system is transitioned to the new back-end, it will no longer need to rely on its own data store and on an EAI system to keep that data store synchronized. Consequently, the EAI system will gradually transition from being the hub of the entire system, to merely a spoke, to not being required at all.

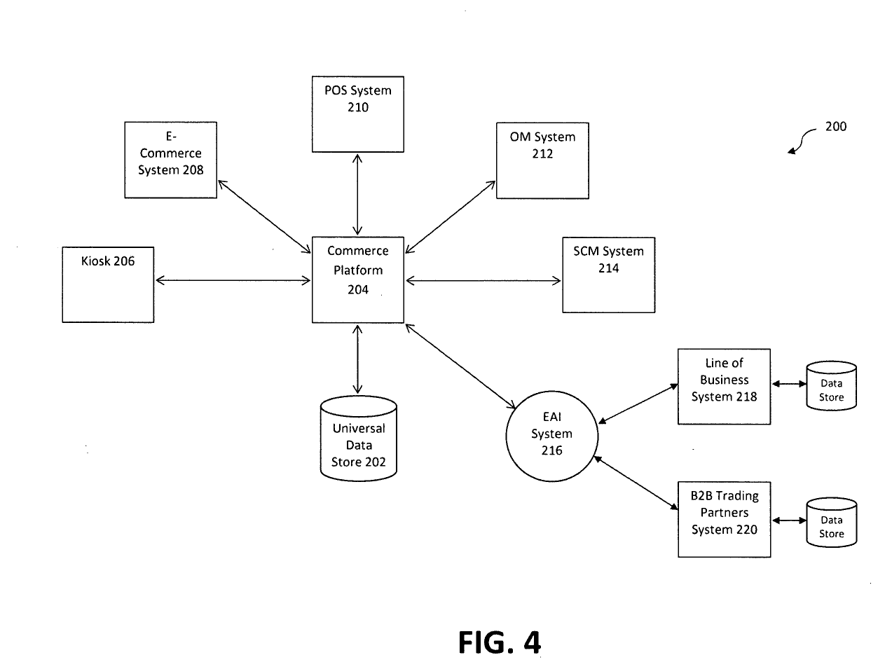

FIG. 4 depicts a particular implementation of system 200 of FIG. 2 that illustrates various types of enterprise application systems that may be supported by that system. As shown in FIG. 4, enterprise application system 206 may be a kiosk, enterprise application system 208 may be an e-commerce system, enterprise application system 210 may be a POS system, enterprise application system 212 may be an OM system, and enterprise application system 214 may be an SCM system. Furthermore, legacy enterprise application system 218 may be any type of line of business system while legacy enterprises application system 220 may be a system for exchanging information with business-to-business (B2B) trading partners. System 220 may be operated by the same business organization that operates data store 202/commerce platform 204, or by a different entity or entities (such as one or more trading partners). Alternatively, system 220 may include some components that are operated by the same business organization that operates data store 202/commerce platform 204 and some components that are operated by a different entity or entities. However, these examples are not intended to limit the present invention. Persons skilled in the relevant art(s) will readily appreciate that other enterprise application systems may be supported in accordance with various implementations of the present invention.

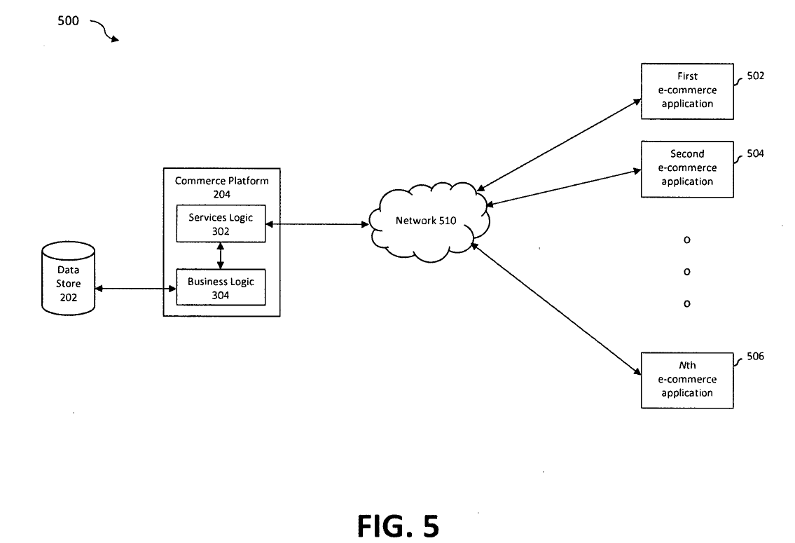

FIG. 5 depicts a system 500 in accordance with a particular implementation of the present invention in which data store 202 and commerce platform 204 support the use of “punch out” technology. Such technology can be used to make a company's products and services available to consumers via a variety of different e-commerce applications. In accordance with this scenario, a business organization uses central data store 202/commerce server 204 to make goods or services available in a form that is accessible by multiple different e-commerce applications. Such goods or services may be made available, for example, in the form of a Web-based product catalog.

In further accordance with this scenario, each of the e-commerce applications is configured to allow a user to “punch out” from the application to browse and optionally buy goods or services made available via the Web catalog. The e-commerce applications may be hosted by the same business organization that is operating data store 202/commerce server 204, by one or more third-party business organizations, or by any combination of the foregoing. As shown in FIG. 5, the e-commerce applications include a first e-commerce application 502, a second e-commerce application 504, and an nth e-commerce application 506, where n may be any positive integer.

Each e-commerce application remotely accesses the Web-based product catalog by sending requests via network 510 to services logic 302 within commerce platform 204 and by optionally receiving responses to such requests. Each e-commerce application maintains a connection with commerce platform 204 so that relevant information about any commercial transactions conducted by a user is delivered back to the corresponding e-commerce application for processing.

In accordance with system 500, a business organization can use data store 202/commerce platform 204 to operate a back-end system and then sell products and services through multiple diverse front-ends, each of which may be hosted by the business organization itself or by a third-party business organization. For example, a company that is in the business of selling digital music on-line may create a Web catalog of such music and then allow multiple e-commerce applications to provide “punch out” access to the Web catalog for the purposes of browsing and making purchases. This approach is advantageous in that multiple point-to-point systems do not need to be developed in order to facilitate transactions between the front-end e-commerce applications and the back-end system. Also, the back-end product/service provider does not need to develop a separate Web catalog or interface to accommodate each front-end e-commerce application.

In addition to using the back-end system to support “punch out” transactions from multiple different e-commerce applications, it is to be understood that the company operating the back-end system can also use data store 202/commerce platform 204 as described above in reference to FIG. 2 and FIG. 4 to support any number of heterogeneous enterprise application systems. Thus, a single deployment of data store 202/commerce platform can be used to support any or all of the enterprise application systems shown in FIG. 2 and FIG. 4 as well as the different c-commerce applications shown in FIG. 5.

### B. Example Data Store and Commerce Platform

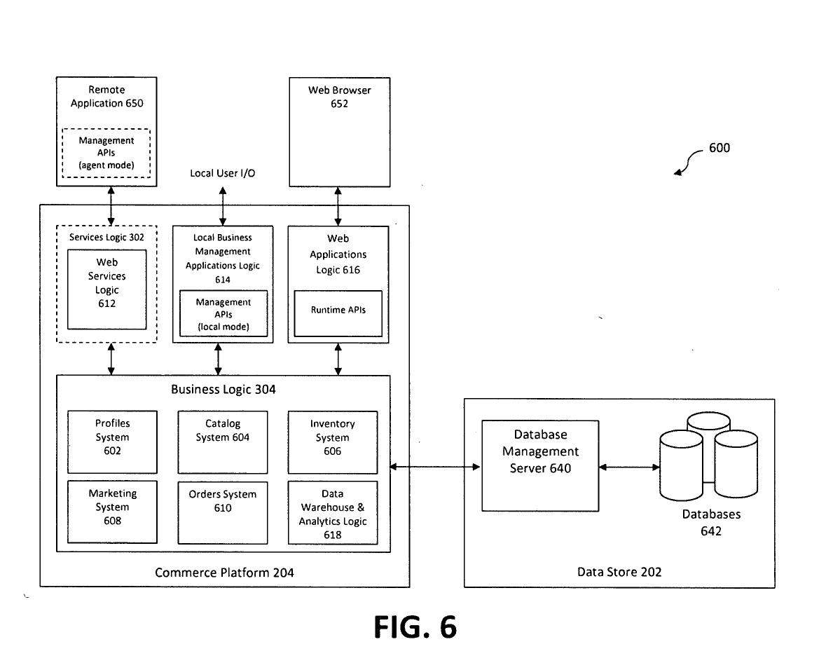

FIG. 6 is a block diagram 600 that provides a more detailed view of data store 202 and commerce platform 204 in accordance with one implementation. The implementation depicted in FIG. 6 and described herein is provided by way of example only and is not intended to limit the present invention. Persons skilled in the relevant art(s) will readily appreciate that other implementations of data store 202 and commerce platform 204 may be used. Such other implementations are within the scope and spirit of the present invention.

As shown in FIG. 6, data store 202 includes a plurality of databases 642 as well as a database management server 640. Databases 642 serve to store commerce-related data generated and/or used by one or more applications or systems supported by commerce platform 204. Databases 642 may include databases that are uniquely associated with one or more commerce-related systems implemented within business logic 304 of commerce platform 204. Databases 642 may further include an administrative database that stores data used for configuring and managing commerce platform 204. Databases 642 may still further include a data warehouse database that is used by data warehouse and analytics logic within business logic 304 of commerce platform 204 in a manner to be described in more detail herein.

Database management server 640 is configured to receive database management service requests from commerce platform 204, and optionally from other clients (including other instances of commerce platform 204), and to optionally provide responses to those database management service requests. Database management server 640 is further configured to access databases 642 for the purposes of adding, deleting, modifying or obtaining copies of the data stored therein responsive to database management service requests. In one embodiment, database server 640 is configured to use Structured Query Language (SQL) for performing database operations. For example, in one embodiment, database server 640 is implemented using Microsoft® SQL Server™ 2000 or Microsoft® SQL Server™ 2005, each of which is published by Microsoft Corporation of Redmond, Wash.

As discussed above in reference to FIG. 3, commerce platform 204 includes business logic 304 that is configured to perform operations on commerce-related data stored in data store 202. In accordance with the implementation shown in FIG. 6, business logic 304 includes logic for implementing a plurality of systems, each of which is configured to perform operations that relate to a particular aspect or type of commercial activity. In particular, as shown in FIG. 6, business logic 304 includes a profiles system 602, a catalog system 604, an inventory system 606, a marketing system 608, and an orders system 610. Each of these systems will now be described in further detail.

Profiles system 602 is configured to allow a user to store and retrieve profiles that represent business objects. Profiles system 602 uses profile definitions to specify properties that each instance of a profile will have. Profile definitions may be predefined or created by a user. Profiles system 602 allows a user to create an instance of a profile by providing values for the properties. Examples of business objects that may be represented using profiles include users, organizations, addresses, credit cards, currencies, and purchase orders. Profiles and profile definitions may be stored in one or more of databases 642.

Catalog system 604 is configured to allow a user to access, search, create, manage, import or export one or more product catalogs, each of which may be stored in one or more of databases 642. A product catalog provides a structure for organizing information about products that a business organization wishes to sell. A product catalog may include a group of categories and products. It may further contain descriptions and pricing information. Such product catalog information may be used, for example, to support an on-line shopping application, to create aggregated or “virtual” product catalogs by combining one or more categories or catalogs, to associate products with product families, or to support product search tools. Catalog system 604 may be integrated with the inventory system so that the availability of products in a product catalog may be assessed.

Inventory system 606 is configured to allow a user to access, search, create, manage, import or export inventory items and catalogs. Such inventory items and catalogs may be stored in one or more of databases 642. In particular, inventory system 606 allows a user to update the inventory of items in an inventory catalog and monitor depletion. Inventory system 606 is further configured to allow a user to create an inventory catalog and populate it with inventory information for all products from a product catalog as well as to import and export inventory from and to external systems. Inventory system 606 may be used to determine the inventory condition of a product, including current quantities on hand, an out-of-stock threshold, and whether the item can be back-ordered and to what quantity. Inventory system 606 may be integrated with catalog system 604 to allow a user to filter product listings by only products that are in stock. Inventory system 606 may further be integrated with orders system 610 to decrement inventory levels with order transactions.

Marketing system 608 is configured to allow a user to create marketing programs that use one or more communication vehicles to accomplish a specific result, such as increasing market share, introducing a new product, or retaining customers. Marketing system 608 further allows a user to create and publish promotional prices on products or product groups. Such promotional prices may be made available only to users that meet certain specified conditions. Discount interactions, order-level discounts, and targeting expressions are also supported. Marketing system 608 further allows a user to deliver personalized content to one or more customers or business entities, to host expression-based, targeted advertisements for a product on a Web site, and to distribute e-mail message ads to a targeted group of users. Information for supporting such marketing activities may be stored in one or more of databases 642.

Orders system 610 is configured to facilitate the placing of orders on a Web site. Orders system 610 provides a representation of orders, both in progress (sometimes called “baskets”) and after the order has been placed (sometimes called “purchase orders”). Orders system 610 persists purchase orders to a database, such as one of databases 642, for later searching or processing by business systems. Orders system 610 also provides a mechanism for processing orders (sometimes called “pipelines”) during the lifetime of an order. Orders system 610 may be used, for example, to allow an on-line user to add items to a shopping basket, add items to a wish list, recurring basket, or gift registry, view a basket on a Web site, check out and purchase a basket, find, modify, and delete baskets, find, modify, and delete purchase orders, and process punch-outs to accept baskets via a Web service.

As shown in FIG. 6, business logic 304 also includes data warehouse and analytics logic 618. This logic enables a user to export various types of operational data created or managed by commerce platform 204 into a data warehouse database maintained by database server 640. Data warehouse and analytics logic 618 further permits a user to perform various types of analyses on the operational data stored in the data warehouse database and to use reporting services logic provided by database server 604 to generate reports based on such analyses.

The functions provided by business logic 304, and the various systems included therein, are exposed to a user through one or more of Web applications logic 616, local business management applications logic 614, or Web services logic 612.

Web applications logic 616 is logic that is configured to implement one or more Web applications. Each Web application is configured to receive requests from one or more remotely-executing Web browsers, such as Web browser 652, and to serve responses to the browsers in response to receiving the requests. Such responses are optionally served with data content, which may include Web pages. The requests received from the Web browsers may comprise Hypertext Transfer Protocol (HTTP) requests and the responses served to the browser may comprise HTTP responses, although other standard or proprietary protocols may be used. The Web pages may include HTML documents and linked objects.

In particular, each Web application is configured to serve Web pages to a remotely-executing Web browser that permit the user of the Web browser to issue requests for accessing the functionality of business logic 304. A user of a Web browser interacts in a well-known manner with objects within a Web page served by the Web application to cause the Web application to generate the requests. Each Web application is also configured to provide content received from business logic 304 to the user by sending responses to the user's Web browser. In this manner, each Web application acts as a proxy between a Web browser and business logic 304.

Web application logic 616 includes run-time APIs that are invoked by Web application logic 616 to access the functions of business logic 304. The run-time APIs are stored locally with respect to commerce platform 204 and are dynamically loaded by each Web application during execution. In one embodiment, Web application logic 616 includes a different run-time API for each system within business logic 304. The manner in which the run-time APIs are structured may be dictated by a public or proprietary standard. In one embodiment of the present invention, the runtime APIs are Microsoft®.NET™ APIs that are adapted to interact with business logic programmed using ASP.NET or ASP.NET 2.0. However, this example is not intended to be limiting and other APIs may be used.

Web applications implemented by Web applications logic 616 may be used, for example, to allow a user of a remotely-executing Web browser to retrieve information about a product in an on-line product catalog, or to purchase or otherwise order products that are browsed on-line, placed in a virtual basket, and ultimately acquired by going through an automated check-out process. However, these examples are not intended to be limiting, and the Web applications implemented by Web applications logic 616 may be used to perform any of a wide number of commerce-related activities.

Local business management applications logic 614 implements one or more local business management applications. Each local business management application is configured to execute on the same system as commerce platform 204 and therefore is intended for use by a local user of commerce platform 204. The local business management applications may be used to manage data maintained within data store 202 by accessing functions provided by business logic 304. The local business management applications may be used in particular to provide tools that business users and information technology (IT) professionals use in the course of day-to-day management of commerce platform 204. Examples of local business management applications include, for example, a customer and orders manager, a catalog manager, a marketing manager, and a catalog and inventory schema manager.

Local business management applications logic 614 includes a set of management APIs that are invoked by local business management applications logic 614 to access the functionality of business logic 304. The management APIs are stored on the same machine or system as commerce platform 204 and are adapted to access the functionality of business logic 304 directly (as opposed to via Web services accessed over a network). Thus, these APIs may be termed “local mode” management APIs. In one embodiment, local business management applications logic 616 includes a different management API for each system within business logic 304. The manner in which the management APIs are structured may be dictated by a public or proprietary standard.

In the system shown in FIG. 6, services logic 302 is implemented as Web services logic 612. Web services logic 612 implements a set of Web services that can be used by a remotely-located entity to access the functionality of business logic 304 via a network. These Web services may provide access through a SOAP interface or other standard interface for providing Web services including but not limited to REST (Representational State Transfer), JSON (JavaScript Object Notation) or XML. Alternatively, the Web services may provide access through a proprietary interface.

As shown in FIG. 6, Web service requests may be received from a remote application 650. These Web service requests may optionally be implemented using “agent mode” management APIs that are adapted for such remote access. In an embodiment, the agent mode management APIs provide the same object model as is available locally using the local mode management APIs. This facilitates the creation of remote applications by allowing programming logic used to implement local business management applications to be re-used with only relatively minor modifications.

As an alternative to implementing Web service requests using agent mode management APIs, remote application 650 may be programmed directly to the Web services upon which the agent mode management APIs rely. Programming directly to the Web services may be appropriate in certain integration scenarios in which using the agent mode management APIs is not straightforward or even feasible. However, in an embodiment in which several Web service calls may be required to implement a single agent mode management API, programming to the Web services directly may not be quite as easy as using an equivalent agent mode management API.

In accordance with one embodiment of the present invention, commerce platform 204 is implemented at least in part by using features of Microsoft® Commerce Server 2007, published by Microsoft Corporation of Redmond, Wash.

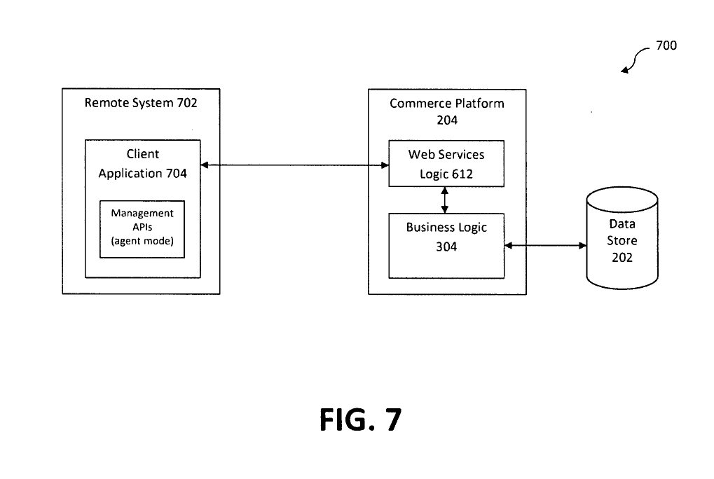

FIGS. 7, 8 and 9 illustrate different modes by which a remote application may access the functionality of business logic 304 via the Web services provided by Web services logic 612. Each of these modes may be used by an enterprise application executing on a remote system in accordance with an embodiment of the present invention. For example, each of these modes may be used by an application running on any of the enterprise application systems shown in FIG. 2 or FIG. 4.

FIG. 7 depicts a system 700 in which a client application 704 is executing on a system 702 that is remotely located with respect to commerce platform 204 and data store 202. Client application 704 may be, for example, any application configured to execute on a computing platform running a Microsoft® Windows® operating system. As shown in FIG. 7, client application 704 includes agent mode management APIs that may be invoked by client application 704 to access the Web services provided by Web service logic 612 over a network. The Web services may be accessed using SOAP or any other standard or proprietary interface for providing Web services. This permits client application 704 to manage commerce-related data stored in data store 202.

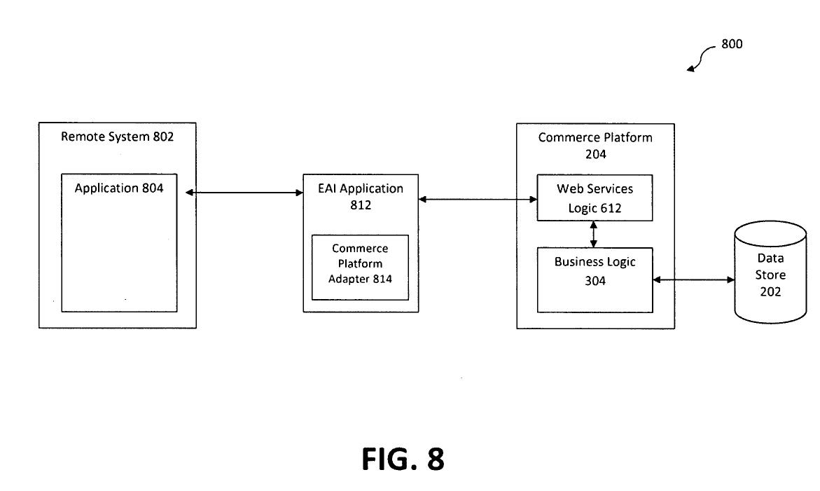

FIG. 8 depicts a system 800 in which an application 804 is executing on a system 802 that is remotely located with respect to commerce platform 204 and data store 202. Unlike client application 704, application 804 is not configured to invoke the Web services provided by Web services logic 612 of commerce platform 204. Instead, application 804 communicates with an EAI application 812 that is configured to invoke such services. In particular, EAI application 812 includes at least one commerce platform adapter 814 that includes agent mode management APIs necessary for remotely invoking the Web services provided by Web services logic 612. Thus, EAI application 812 may act as an intermediary between application 804 and commerce platform 204, extending the capabilities of application 804 to include the various data management services provided by commerce platform 204. EAI application 812 may be running on remote system 802 or on a system that is communicatively connected to remote system 802 over a network. In one embodiment, EAI application 812 comprises Microsoft® BizTalk® Server 2006, published by Microsoft Corporation of Redmond, Wash., although the invention is not so limited.

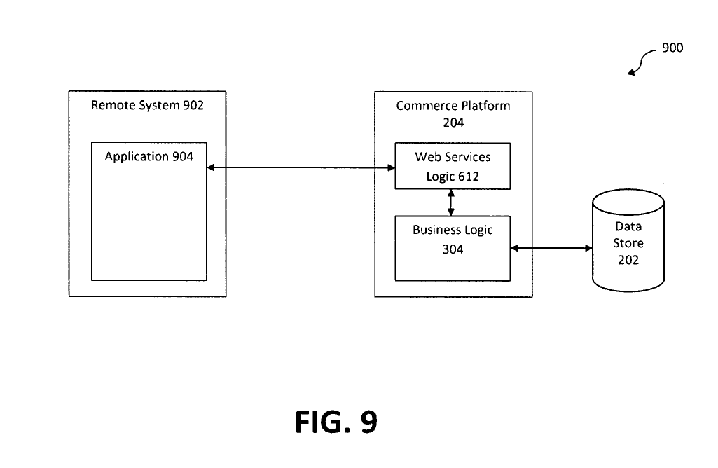

FIG. 9 depicts a system 900 in which an application 904 is executing on a system 902 that is remotely located with respect to commerce platform 204 and data store 202. Unlike client application 704 and EAI application 812, application 904 does not include agent mode management APIs necessary for remotely invoking the Web services provided by Web services logic 612. Instead, application 904 is programmed directly to the Web services provided by Web services logic 612. As noted above, programming directly to the Web services may be appropriate in certain integration scenarios in which using the agent mode management APIs is not straightforward or even feasible. Communication between application 904 and Web services logic may be implemented in accordance with ASMX, Web Services Enhancements (WSE), Windows Communication Foundation (WCF), or any other standard or proprietary distributed communication technology, although the invention is not so limited.

### C. Example Method for Managing Commerce-Related Data

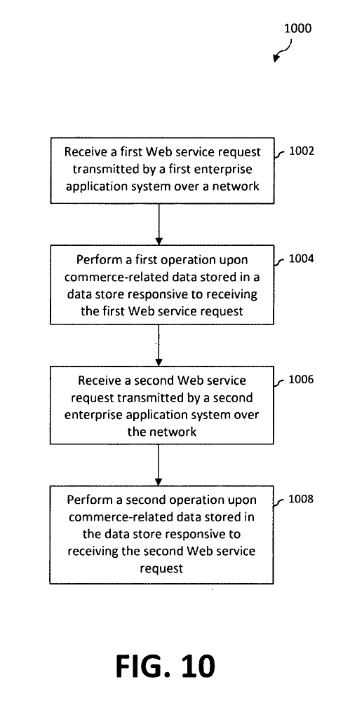

FIG. 10 illustrates a flowchart 1000 of a method for managing commerce-related data in accordance with an embodiment of the present invention. The method of flowchart 1000 is described herein by way of example only and is not intended to limit the present invention. Furthermore, although the steps of flowchart 1000 may be described with reference to various logical and/or physical entities and systems that have been described elsewhere herein, persons skilled in the relevant art(s) will readily appreciate that the method need not be implemented using such entities and systems.

The method of flowchart 1000 begins at step 1002 in which a first Web service request transmitted by a first enterprise application system is received over a network. The first enterprise application system may be, for example, any of the enterprise application systems 206, 208, 210, 212 or 214 depicted in FIGS. 2 and 4. The network may comprise any network suitable for transporting data between remote entities, including but not limited to the Internet, an intranet, or an extranet. The first Web service request may be received, for example, by Web services logic 612 within commerce platform 204. In an embodiment, the first Web service request is formatted in accordance with a predefined source code structure, such as a predefined API or Web services code structure.

At step 1004, a first operation is performed upon commerce-related data stored in a data store responsive to receipt of the first Web service request. For example, in accordance with this step, business logic 304 within commerce platform 204 may perform a first operation upon commerce-related data stored in data store 202. This first operation may include adding, deleting or modifying data in data store 202, returning a copy of data stored in data store 202, or performing some other action with respect to the data stored in data store 202. The commerce-related data within data store 202 may include any type of commerce-related data including but not limited to product catalog information, master merchandise information, product inventory information, customer profile information, organizational profile information, and promotional information.

At step 1006, a second Web service request transmitted by a second enterprise application system is received over the network. The second enterprise application system may be, for example, any of the enterprise application systems 206, 208, 210, 212 or 214 depicted in FIGS. 2 and 4, provided that it is not the same enterprise application system referred to in step 1002. Consequently, the first and second enterprise application systems are heterogeneous systems as discussed above in reference to those figures. The second Web service request may be received by Web services logic 612 within commerce platform 204. In an embodiment, the second Web service request is formatted in accordance with the same predefined source code structure as the first Web service request. As noted above, the predefined source code structure may comprise a predefined API or Web services code structure.

At step 1008, a second operation is performed upon the commerce-related data stored in the data store responsive to receipt of the second Web service request. For example, in accordance with this step, business logic 304 within commerce platform 204 may perform a second operation upon commerce-related data stored in data store 202. This second operation may include adding, deleting or modifying data in data store 202, returning a copy of data stored in data store 202, or performing some other action with respect to the data stored in data store 202.

As will be appreciated by persons skilled in the relevant art(s), the foregoing method advantageously permits multiple heterogeneous enterprise application systems to use a single centralized data store for performing data management operations. The use of such a centralized data store is superior to conventional scenarios in which each enterprise application system within an organization implements its own data store and in which point-to-point systems or EAI message brokers are used to synchronize the data stored by each system.

It should be noted that the various steps depicted in flowchart 1000 need not occur in the precise order shown. For example, the receipt of the second Web service request may precede or occur contemporaneously with the receipt of the first Web service request. Likewise, the performance of the second operation upon commerce-related data in the data store may precede or occur contemporaneously with the performance of the first operation. In fact, the only time requirements imposed upon the steps of flowchart 1000 is that step 1004 occur after step 1002 and that step 1008 occur after step 1006.

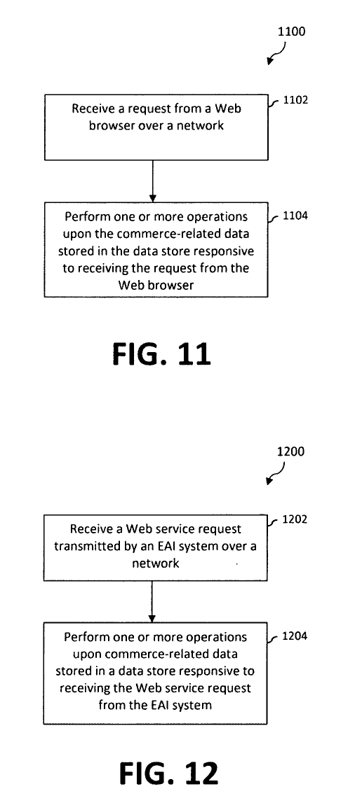

FIG. 11 depicts a flowchart 1100 of steps that may be performed in addition to the steps of flowchart 1000 in accordance with an embodiment of the present invention. The steps of flowchart 1100 are described herein by way of example only and are not intended to limit the present invention.

Furthermore, although the steps of flowchart 1100 may be described with reference to various logical and/or physical entities and systems that have been described elsewhere herein, persons skilled in the relevant art(s) will readily appreciate that the method need not be implemented using such entities and systems.

As shown in FIG. 11, the additional steps include step 1102, in which a request is received from a Web browser over a network. The Web browser may be, for example, Web browser 652 depicted in FIG. 6. The network may comprise any network suitable for transporting data between remote entities, including but not limited to the Internet, an intranet, or an extranet. The request may be a request that is received, for example, by Web applications logic 616 within commerce platform 204. In an embodiment, the request is formatted in accordance with an HTTP protocol.

At step 1104, one or more operations are performed upon the commerce-related data stored in the data store responsive to receipt of the request from the Web browser. For example, in accordance with this step, business logic 304 within commerce platform 204 may perform one or more operations upon commerce-related data stored in data store 202. These operations may include adding, deleting or modifying data in data store 202, returning a copy of data stored in data store 202, or performing some other action with respect to the data stored in data store 202.

As will be appreciated by persons skilled in the relevant art(s), the foregoing steps of flowchart 1100 may advantageously be used to extend the back-end functionality of the centralized data store and commerce platform to lines of business that are served by browser-based applications, such as on-line Web storefronts or any other of a wide variety of e-commerce applications.

FIG. 12 depicts a flowchart 1200 of additional steps that may be performed in addition to the steps of flowchart 1000 in accordance with an embodiment of the present invention. The steps of flowchart 1200 are described herein by way of example only and are not intended to limit the present invention. Furthermore, although the steps of flowchart 1200 may be described with reference to various logical and/or physical entities and systems that have been described elsewhere herein, persons skilled in the relevant art(s) will readily appreciate that the method need not be implemented using such entities and systems.

As shown in FIG. 12, the additional steps include step 1202, in which a service request transmitted by an EAI system is received over a network. The EAI system may be, for example, EAI system 216 depicted in FIGS. 2 and 4, or a system running EAI application 812 depicted in FIG. 8. In an embodiment, the EAI request is generated by a commerce platform adapter within the EAI system. The network may comprise any network suitable for transporting data between remote entities, including but not limited to the Internet, an intranet, or an extranet. The Web service request may be received, for example, by Web services logic 612 within commerce platform 204. In an embodiment, the Web service request is formatted in accordance with a predefined source code structure, such as a predefined API or Web services code structure.

At step 1204, one or more operations are performed upon the commerce-related data stored in the data store responsive to receipt of the Web service request from the EAI system. For example, in accordance with this step, business logic 304 within commerce platform 204 may perform one or more operations upon commerce-related data stored in data store 202. These operations may include adding, deleting or modifying data in data store 202, returning a copy of data stored in data store 202, or performing some other action with respect to the data stored in data store 202.

As will be appreciated by persons skilled in the relevant art(s), the foregoing steps of flowchart 1200 may advantageously be used to extend the back-end functionality of the centralized data store and commerce platform to lines of business that are served by legacy enterprise application systems that maintain their own data stores and that rely on EAI application systems to synchronize such data stores with the centralized data store. Furthermore, the foregoing steps of flowchart 1200 may advantageously be used to extend the Web services offered by the commerce platform to applications that are not configured to invoke such Web services. Such applications can instead work with an intermediate EAI application that includes a commerce platform adapter configured to invoke such Web services.

### D. Example Server Computer

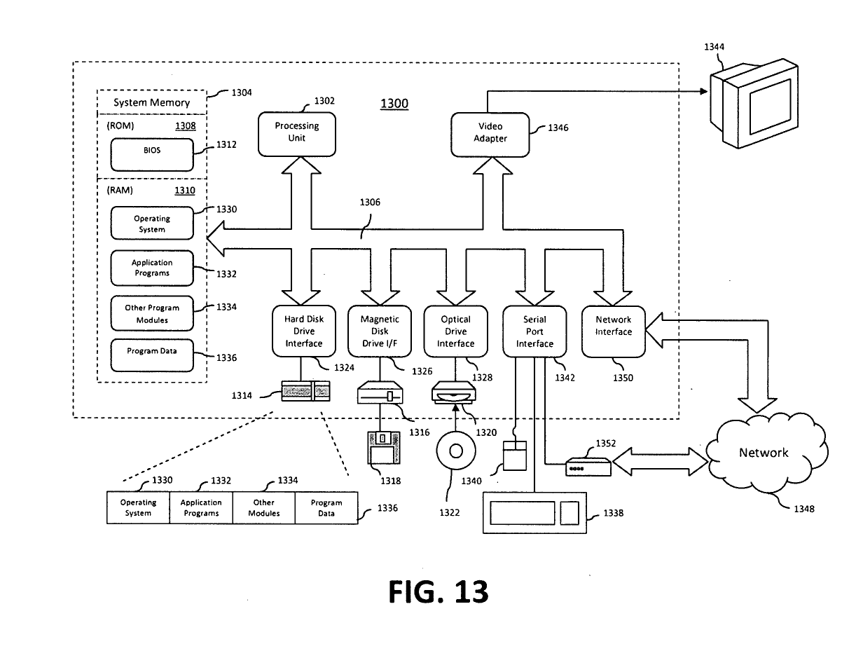

FIG. 13 depicts an exemplary implementation of a server computer 1300 upon which commerce platform 204 and/or database server 640 may be executed. Server computer 1300 is a general-purpose computing device in the form of a conventional personal computer that is configured to operate as a Web server.

As shown in FIG. 13, server computer 1300 includes a processing unit 1302, a system memory 1304, and a bus 1306 that couples various system components including system memory 1304 to processing unit 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Server computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the server computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, logic for implementing the elements of commerce platform 204 and/or database server 640, as described above.

A user may enter commands and information into the server computer 1300 through input devices such as keyboard 1338 and pointing device 1340. Other input devices (not shown) may include a microphone, joystick, game pad, satellite dish, scanner, or the like. These and other input devices are often connected to the processing unit 1302 through a serial port interface 1342 that is coupled to bus 1306, but may be connected by other interfaces, such as a parallel port, game port, or a universal serial bus (USB).

A monitor 1344 or other type of display device is also connected to bus 1306 via an interface, such as a video adapter 1346. Monitor 1344 is used to present a graphical user interface that assists a user/operator in configuring commerce platform 204 and/or data store 640. In addition to the monitor, server computer 1300 may include other peripheral output devices (not shown) such as speakers and printers.

Server computer 1300 is connected to a network 1348 (e.g., the Internet) through a network interface or adapter 1350, a modem 1352, or other means for establishing communications over the network. Modem 1352, which may be internal or external, is connected to bus 1306 via serial port interface 1342.

As used herein, the terms “computer program medium” and “computer-readable medium” are used to generally refer to media such as the hard disk associated with hard disk drive 1314, removable magnetic disk 1318, removable optical disk 1322, as well as other media such as flash memory cards, digital video disks, random access memories (RAMs), read only memories (ROM), and the like.

As noted above, computer programs (including application programs 1332 and other program modules 1334) may be stored on the hard disk, magnetic disk, optical disk, ROM, or RAM. Such computer programs may also be received via network interface 1350 or serial port interface 1342. Such computer programs, when executed, enable server computer 1300 to implement features of the present invention discussed herein. Accordingly, such computer programs represent controllers of the server computer 1300.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### E. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A commerce-related data management system, comprising:
a data store that stores commerce-related data;
business logic configured to access the commerce-related data stored in the data store; and
Web services logic configured to receive service requests transmitted by a plurality of heterogeneous enterprise application systems over a network;
the business logic being further configured to perform one or more operations upon the commerce-related data stored in the data store responsive to receipt of the service requests by the Web services logic.

2. The system of claim 1, wherein the service requests received from each of the plurality of heterogeneous enterprise application systems are formatted in accordance with a common source code structure.

3. The system of claim 1, wherein the commerce-related data comprises one or more of:
product catalog information;
master merchandise information;
product inventory information;
customer profile information;
organizational profile information; and
promotional information.

4. The system of claim 1, wherein the business logic comprises one or more of:
a profiles system;
a product catalog system;
an inventory system;
a marketing system; and
an orders system.

5. The system of claim 1, further comprising:
an enterprise application system remotely connected to the Web services logic via the network and configured to transmit service requests to the Web services logic.

6. The system of claim 5, wherein the enterprise application system is one of:
a Point-of-Sale (POS) system;
a kiosk;
an e-commerce system;
a product line manager system;
a product information management system;
an inventory management system;
a warehouse management system;
an order management system;
a supply chain automation system; or
a supply chain management system.

7. The system of claim 1, further comprising:
Web application logic configured to receive requests from a Web browser;
wherein the business logic is further configured to perform one or more operations upon the commerce-related data responsive to receipt of the requests by the Web application logic.

8. The system of claim 1, further comprising:
an enterprise application integration (EAI) system connected to the Web services logic over the network and configured to send service requests to the Web services logic;
wherein the EAI system is further connected to one or more additional enterprise application systems.

9. A method for managing commerce-related data used by a first enterprise application system and a second enterprise application system, wherein the first and second enterprise application systems are heterogeneous systems, the method comprising:
receiving a first Web service request transmitted by the first enterprise application system over a network;
performing a first operation upon commerce-related data stored in a data store responsive to receiving the first Web service request;
receiving a second Web service request transmitted by the second enterprise application system over the network;
performing a second operation upon the commerce-related data stored in the data store responsive to receiving the second Web service request.

10. The method of claim 9, wherein the first and second Web service requests are each formatted in accordance with the same predefined source code structure.

11. The method of claim 10, wherein the first and second Web service requests are each formatted in accordance with one of the same application programming interface (API).

12. The method of claim 9, wherein performing a first operation upon the commerce-related data comprises performing an operation upon one of: product catalog information, master merchandise information, product inventory information, customer profile information, organizational profile information, and promotional information.

13. The method of claim 9, wherein receiving the first Web service request transmitted by the first enterprise application system comprises receiving the first Web service request transmitted by one of: a Point-of-Sale (POS) system, a kiosk, an e-commerce system, a product line manager system, a product information management system, an inventory management system, a warehouse management system, an order management system, a supply chain automation system, and a supply chain management system.

14. The method of claim 9, further comprising:
receiving a request from a Web browser;
performing one or more operations upon the commerce-related data stored in the data store responsive to receiving the request from the Web browser.

15. The method of claim 9, further comprising:
receiving a service request transmitted by an enterprise application integration (EAI) system over the network; and
performing one or more operations upon the commerce-related data stored in the database responsive to receiving the request from the EAI system.

16. A computer program product comprising a computer-readable medium having computer program logic recorded thereon for enabling a computer to manage commerce-related data stored in a database, the computer program logic comprising:
first means for enabling the computer to access the commerce-related data stored in the database;
second means for enabling the computer to receive service requests transmitted by a plurality of heterogeneous enterprise application systems over a network; and
third means for enabling the computer to perform one or more operations upon the commerce-related data stored in the database responsive to receipt of the service requests by the second means.

17. The computer program product of claim 16, wherein the second means comprises means for enabling the computer to receive service requests formatted in accordance with a common source code structure.

18. The computer program product of claim 16, wherein the first means comprises means for enabling the computer to access one or more of: product catalog information, master merchandise information, product inventory information, customer profile information, organizational profile information, and promotional information.

19. The computer program product of claim 16, wherein the computer program logic further comprises:
fourth means for enabling the computer to receive requests from a Web browser;
wherein the third means further comprises means for enabling the computer to perform one or more operations upon the commerce-related data stored in the database responsive to receipt of the requests by the fourth means.

20. The computer program product of claim 16, wherein the computer program logic further comprises:
fourth means for enabling the computer to receive service requests transmitted by an enterprise application integration (EAI) system over the network.
